(19) United States
(12) Patent Application Publication
(10) Pub. No.: US 2007/0171387 A1
(43) Pub. Date: Jul. 26, 2007

(54) MICROMIRROR-BASED PROJECTION SYSTEM WITH OPTICS HAVING SHORT FOCAL LENGHTS

(75) Inventors: Regis Grasser, Mountain View, CA (US); Andrew Huibers, Palo Alto, CA (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/626,110

(22) Filed: Jan. 23, 2007

Related U.S. Application Data
(60) Provisional application No. 60/761,485, filed on Jan. 23, 2006.

(51) Int. Cl. G03B 21/28

(52) U.S. Cl. 353/99

(57) ABSTRACT

Disclosed herein is a projection system that comprises an illumination system providing incident light, a projection lens for directing the incident light onto one or more spatial light modulator from where the incident light is modulated in accordance with a stream of image data derived from the desired image, and a projection lens for projecting the modulated light onto a screen.

### CROSS REFERENCE TO RELATED CASES

This US patent application claims priority under 35 U.S.C. 119(e) from co-pending U.S. provisional patent application Ser. No. 60/761,485 to Regiss filed Jan. 23, 2005, the subject matter being incorporated herein by reference in its entirety.

### TECHNICAL FIELD

The technical field of the examples to be disclosed in the following sections is generally related to the art of projection systems, and more particularly, to micromirror-based projection systems having optics of short focal lengths.

### BACKGROUND

Rear-projection systems, such as rear-projection TVs, are projection systems wherein the images are projected on a translucent screen from the side opposite to the viewers. A typical rear-projection system projects the desired images inside a box and directs then projected images by means of optical lenses and folding mirrors onto the inner surface of the translucent screen. The viewer watches the projected images on the inner side of the translucent screen from the outer surface. This type of projection systems are capable of being equipped with large screen than regular TVs, thus, enabling large-sized display, such as 40 inches or larger.

It is desired that, except in some rare cases where a large facility like a movie theater, a rear-projection system be provided with a large screen and be simultaneously compact or slim, i.e. that its depth dimension in the direction perpendicular to the translucent screen be small.

### SUMMARY

Disclosed herein comprises a rear-projection system that comprises an illumination system providing incident light, a projection lens for directing the incident light onto one or more spatial light modulator from where the incident light is modulated in accordance with a stream of image data derived from the desired image, and a projection lens for projecting the modulated light onto a screen.

The spatial light modulator comprises an array of deflectable and reflective mirror plates. The mirror plates each have a characteristic dimension in the order of microns, such as 100 micros or less, 50 microns or less, and 15 microns or less. The mirror plates are arranged in arrays preferably with a pitch of 10.16 microns or less, such as from 4.38 to 10.16 microns. The gap between the adjacent mirror plates is preferably 1.5 microns or less, such as 1 micron or less, 0.5 micron or less, more preferably from 0.1 to 0.5 micron. The mirror plate array preferably has a diagonal from 0.45 to 0.9 inch, such as from 0.55 to 0.8 inch. The total number of mirror plates, which is referred to as the natural resolution of the array, is preferably 640×480 (VGA) or higher, such as 800×600 (SVGA) or higher, 1024×768 (XGA) or higher, 1280×1024 (SXGA) or higher, 1280×720 or higher, 1400×1050 or higher, 1600×1200 (UXGA) or higher, and 1920×1080 or higher.

The mirror plates are operated in an ON and OFF state. The ON state corresponds to a state wherein the mirror plate is rotated to an ON state angle of 10° degrees or more, more preferably 12° degrees or more, 14° degrees or more, and 16.5° degrees or more, 17.5° degrees or more, and 20° degrees or more relative to a substrate on which the mirror plates are formed. The OFF state corresponds to a state wherein the mirror plate is parallel to the substrate on which the mirror plates are formed, or at an OFF angle that is from −0.50 to −10° degrees, preferably from −1° to −9°, or from −1° to −4° degrees relative to the substrate on which the mirror plates are formed.

Because of large ON state angle, light to be modulated can be obliquely incident onto the reflective mirror plates at large acute incident angles. The incident light may have an acute angle φ relative to the reflective surfaces of the mirror plates at the natural resting state. The projection of the incident light on the reflective surfaces has an acute angle of β to an edge of the micromirror array, and an obtuse angle of a ω an edge of the mirror plate. Angle φ is equal to (90°−2×θ_{ON}) with θ_{ON} being the ON state angle. Depending upon θ_{ON}, angle φ can be 70° degrees or less, such as 66° degrees or less, 62° degrees or less, and 57° degrees or less. Angle β can be of any suitable values, such as from 0° to 90° degrees, and from 20° to 65° degrees, from 50° to 65° degrees, and more preferably around 32.8 degrees. Obtuse angle ω can be any suitable values, depending upon the geometric shape of the mirror plate. In the instance wherein the mirror plate is substantially square, the obtuse angle ω can be from 90° degrees to 135° degrees, such as from 105° degrees to 135° degrees, from 119° degrees to 135° degrees, and from 113° degrees to 135° degrees, and from 122.8° degrees to 135° degrees.

The incident light can be provided by any suitable light sources, such as arc lamps, lasers, and LEDs. Specifically, an array of LEDs can be provided as the light source. The LEDs may have the same, similar, or different characteristic spectrums of different colors.

The spatial light modulator modulates the incident light in accordance with a stream of image data derived from the desired images. The modulated light is projected by a projection lens. Because the incident light can be obliquely incident onto the spatial light modulator, the projection lens can be positioned at a distance Dₘᵢₙ from the reflective surfaces of the mirror plates determined by the equation of:

$${D}_{min} \geq \frac{L}{{tan}^{- 1} ( {θ}_{in} + ϕ ) - tan ( {θ}_{re} )}$$

wherein L is the characteristic dimension of the micromirror device array, θᵢₙ, is the half-angle of the incident light cone, θᵣₑ is the half-angle of the reflected light cone. In particular, the distance can be 186 mm or less, 40 mm or less, 33 mm or less, 27 mm or less, 24 mm or less, 20.7 mm or less, 18 mm or less, and 17 mm or less. Accordingly, the projection lens may have a back-focal length of 186 mm or less, 40 mm or less, 33 mm or less, 27 mm or less, 24 mm or less, 20.7 mm or less, 18 mm or less, and 17 mm or less. The f-number of the projection lens can be from f/1.8 to f/4, more preferably around f/2.4 with f being the back-focal length.

### BRIEF DESCRIPTION OF THE DRAWINGS

FIG. 1 illustrates an exemplary micromirror-based rear projection system;

FIG. 2a illustrates a cross-sectional view of the incident light and the spatial light modulator in FIG. 1;

FIG. 2b demonstrates the geometric relations of the spatial light modulator, the incident light and the modulate light;

FIG. 3 illustrates an exemplary illumination system for use in the projection system of FIG. 1;

FIG. 4 illustrates another exemplary illumination system for use in the projection system of FIG. 1;

FIG. 5 illustrates another exemplary micromirror-based rear-projection system;

FIG. 6 illustrates a cross-sectional view of an exemplary spatial light modulator for use in the projection system of FIG. 1 and FIG. 2;

FIG. 7 is a cross-sectional view of an exemplary micromirror device for use in the spatial light modulator of FIG. 6;

FIG. 8 is a perspective view of an exemplary micromirror device of FIG. 7;

FIG. 9 is a perspective view of an exemplary micromirror device of FIG. 7;

FIG. 10 is a perspective view of an exemplary spatial light modulator having an array of micromirror devices in FIG. 9 for use in the projection systems of FIG. 1 and FIG. 5;

FIG. 11 is a top view of another exemplary spatial light modulator having an array of micromirror devices of FIG. 9 for use in the projection systems of FIG. 1 and FIG. 5;

FIG. 12 is a top view of yet another exemplary spatial light modulator having an array of micromirror devices of FIG. 9 for use in the projection systems of FIG. 1 and FIG. 5;

FIG. 13 is a top view of yet another exemplary spatial light modulator having an array of micromirror devices of FIG. 9 for use in the projection systems of FIG. 1 and FIG. 5;

FIG. 14a to FIG. 14c illustrate a top view of yet another exemplary spatial light modulator; and

FIG. 15 is a top view of yet another exemplary spatial light modulator having an array of micromirror devices of FIG. 9 for use in the projection systems of FIG. 1 and FIG. 5.

### DETAILED DESCRIPTION OF EXAMPLES

Disclosed herein is a rear-projection system that comprises an illumination system providing incident light, a projection lens for directing the incident light onto one or more spatial light modulator from where the incident light is modulated in accordance with a stream of image data derived from the desired image, and a projection lens for projecting the modulated light onto a screen.

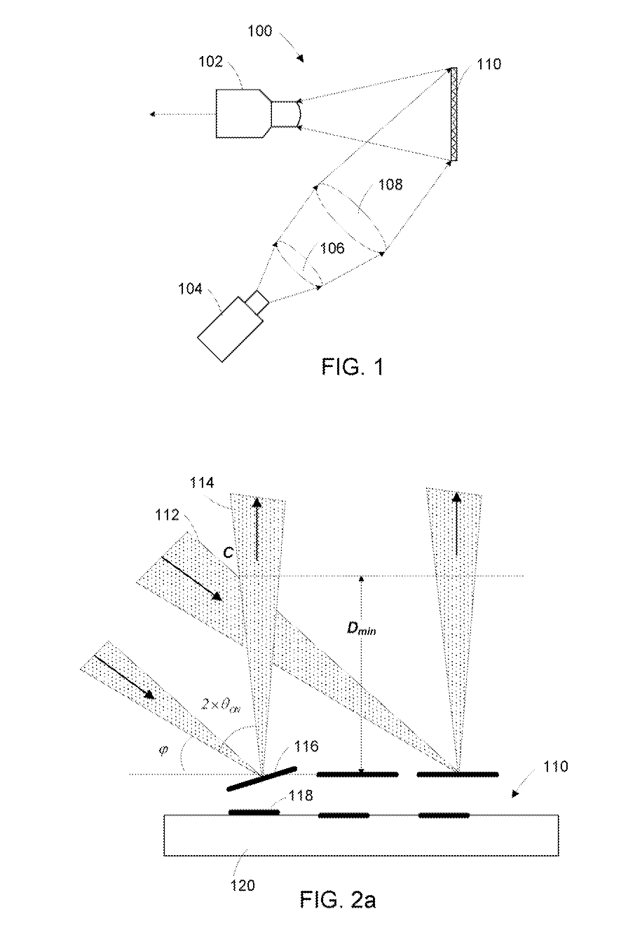

Referring to FIG. 1, an exemplary rear-projection system is demonstratively illustrated therein. Projection system 100 comprises illumination system 104 providing illumination light for the system. Relay lens 106 integrates the illumination light and image the light source on spatial light modulator 1 10. A relay lens is a lens that relays or moves an image plane from one position to another. In the particular example, relay lens 106 images the light pipe of the illumination system onto the spatial light modulator. Field lens 108 guides the illumination light towards the spatial light modulator. A field lens is a lens that is often placed at an image plane for collecting the rays and gilding the rays onto the desired direction. Spatial light modulator 100 comprising an array of reflective and deflectable mirror plates modulates the incident light in accordance with a stream of image data, such as bitplane data, derived from the desired images. The modulated light is collected by projection lens 102 and projected on the inner surface of a translucent screen. Other optical elements, such as optical lenses and folding mirrors can be provided for projecting the modulated light onto the inner surface of the translucent screen. Viewers can then view the projected image on the translucent screen from the outer side. The components of the rear-projection system can be enclosed within a box with the translucent screen being placed as the front surface of the box for viewing.

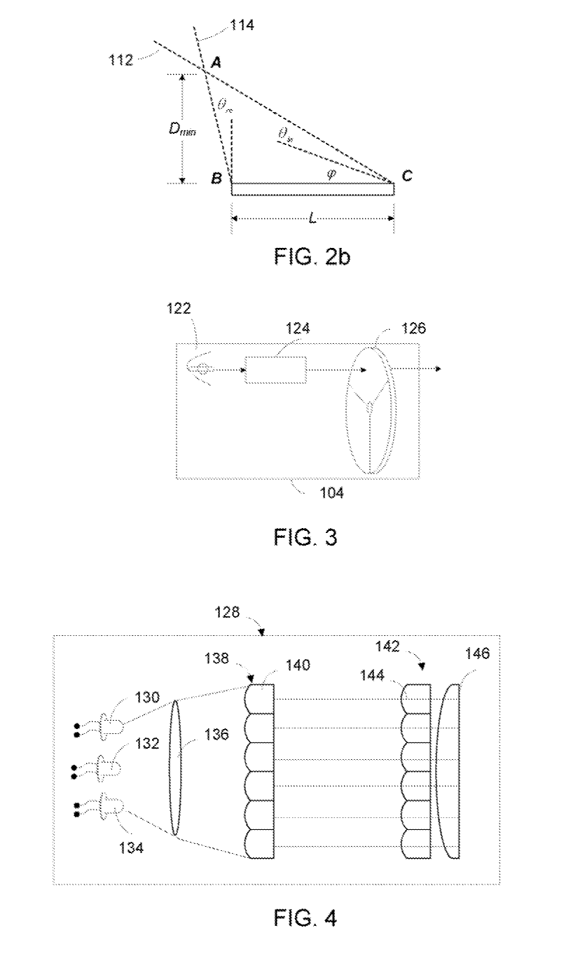

The spatial light modulator comprises an array of deflectable and reflective mirror plates. A cross-section view of the spatial light modulator is illustrated in FIG. 2a. Referring to FIG. 2a, spatial light modulator 110 comprises an array of reflective and deflectable mirror plates, such as mirror plate 116. For simplicity and demonstration purpose, only three mirror plates are shown. For electrostatically deflecting the mirror plates in accordance with the image data, each mirror plate is associated with an addressing electrode, such as addressing electrode 118. The addressing electrodes are formed on semiconductor substrate 120 on which standard integrated circuits can be fabricated thereon using standard integrated circuitry fabrication processes.

In operation, an electrostatic field is established between the mirror plate (e.g. mirror plate 116) desired to be in the ON state and the associated addressing electrode (e.g. addressing electrode 118). The electrostatic field derives an electrostatic force that yields an electrostatic torque to the deflectable mirror plate. With the electrostatic torque, the mirror plate state.

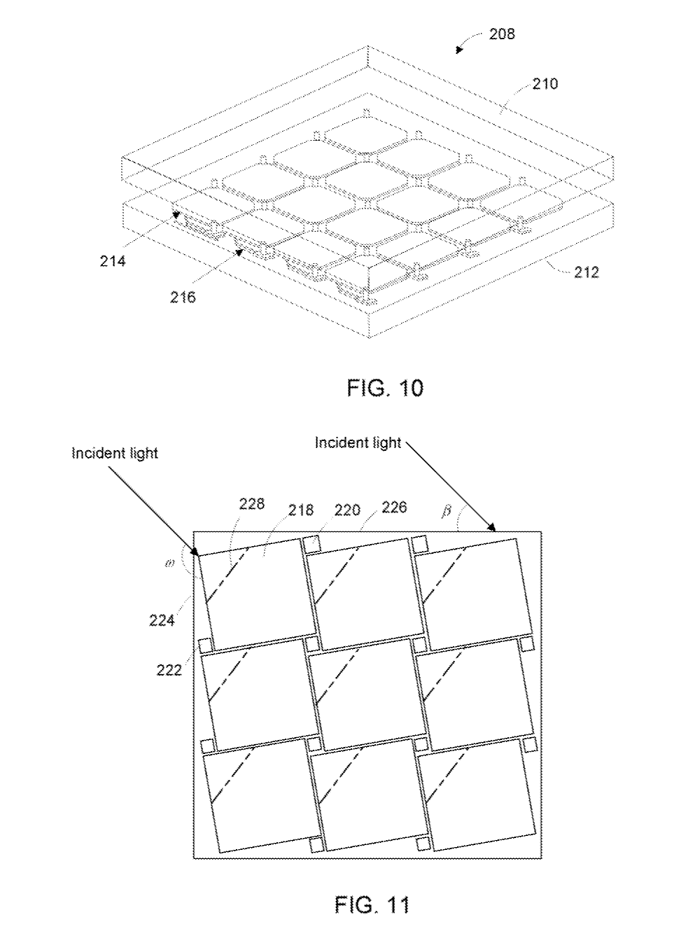

The mirror plates of the spatial light modulator each may have a characteristic dimension in the order of microns, such as 100 micros or less, 50 microns or less, and 15 microns or less. The mirror plates are arranged in arrays (e.g. shown in FIGS. 10, 11, 12, 13, 14a-14c and 15, which will be discussed afterwards) preferably with a pitch of 10.16 microns or less, such as from 4.38 to 10.16 microns. The pitch is defined as the center-to-center distance between two adjacent mirror plates. The gap between the adjacent mirror plates is preferably 1.5 microns or less, such as 1 micron or less, 0.5 micron or less, more preferably from 0.1 to 0.5 micron. The mirror plate array preferably has a diagonal from 0.45 to 0.9 micron, such as from 0.55 to 0.8 micron. The total number of mirror plates, which is referred to as the natural resolution of the array, is preferably 640×480 (VGA) or higher, such as 800×600 (SVGA) or higher, 1024×768 (XGA) or higher, 1280×1024 (SXGA) or higher, 1280×720 or higher, 1400×1050 or higher, 1600×1200 (UXGA) or higher, and 1920×1080 or higher.

The mirror plates are operated in an ON and OFF state. The ON state corresponds to a state wherein the mirror plate is rotated to an ON state angle θ_{ON} of 10° degrees or more, more preferably 12° degrees or more, 14° degrees or more, and 16.5° degrees or more, 17.5° degrees or more, and 20° degrees or more relative to a substrate on which the mirror plates are formed. The OFF state corresponds to a state wherein the mirror plate is parallel to the substrate on which the mirror plates are formed, or at an OFF angle θ_{OFF} that is from −0.5° to −10° degrees, preferably from −1° to −9°, or from −1° to −4° degrees relative to the substrate on which the mirror plates are formed.

Because of large ON state angle, light to be modulated can be obliquely incident onto the reflective mirror plates at large acute incident angles φ. Often times, the incident light is in the form a light cone, as shown in the figure. The incident angle φ is defined as the acute angle between the central axis of the light cone to the reflective surfaces of the mirror plates at the natural resting state (i.e. the non-deflected state). The projection of the incident light on the reflective surfaces has an acute angle of β to an edge of the micromirror array, and an obtuse angle of ω to an edge of the mirror plate, an example of which is illustrated in FIG. 11. As shown in FIG. 11, angle β is defined as the angle between the projection of the incident light on the plane of the reflective surfaces of the mirror plates and mirror array edge 226; and angle ω is defined as the projection of the incident light on the plane of the reflective surfaces of the mirror plates and an edge of mirror plate 218, which will be discussed afterwards.

Referring back to FIG. 2a, angle φ depends from the ON state angle of the mirror plate. Specifically, angle φ is equal to (90°−2×θ_{ON}) with θ_{ON} being the ON state angle. Depending upon θ_{ON}, angle φ can be 70° degrees or less, such as 66° degrees or less, 62° degrees or less, 57° degrees or less, 550 degrees or less, 50° degrees or less, more preferably around 33° degrees. Angle β can be of any suitable values, such as from 0° to 90° degrees, and from 20° to 65° degrees, from 50° to 65° degrees, and more preferably around 32.8 degrees. Obtuse angle ω can be any suitable values, depending upon the geometric shape of the mirror plate. In the instance wherein the mirror plate is substantially square, the obtuse angle ω can be from 90° degrees to 135° degrees, such as from 105° degrees to 135° degrees, from 119° degrees to 135° degrees, and from 113° degrees to 135° degrees, and from 122.8° degrees to 135° degrees.

As shown in the example of FIG. 2a wherein it is assumed mirror plate 116 is at the ON state; while the other mirror plates are at the OFF state, the incident light is folded to the reflected light propagating vertically towards the projection lens (e.g. projection lens 102 in FIG. 1) by mirror plate 116 at the ON state. The angle between the reflected light from the mirror plate at the ON state and incident is 2×θ_{ON}. The reflected light from the mirror plates at the OFF state propagates away from the projection lens.

The large ON state angle enables oblique incident angle, which in turn is advantageous in placing the projection lens closer to the reflective surfaces of the mirror plate, and thus providing opportunities of sliming down the projection system in the direction of depth dimension that is perpendicular to the translucent screen.

The projection lens (e.g. the focal length of the projection lens), the position of the projection lens, and distance between the projection lens and micromirror array of the spatial light modulator are limited by the relative positions of the incident light and reflected light. The shortest distance between the projection lens and the reflective surface of the mirror plates can be such that no incident light will be collected by the projection lens. Given this constraint, the shortest distance Dₘᵢₙ is the distance between point A and the reflective surfaces of the mirror plate, wherein point A is the cross-point of the reflected light and incident light having the longest distance to the reflective surfaces f the mirror plate. For example as shown in FIG. 2a, cross-point A is the cross-point of outer edge 112 of the incident light beam to the mirror plate at one remote end of the mirror plate array and inner edge 114 of the reflected light beam from the mirror plate at the other remote end of the mirror plate array. For mathematically calculating Dₘᵢₙ, FIG. 2a is simplified to FIG. 2B.

Referring to FIG. 2b, edge rays 112 AC and 114 AB of the incident light and reflected light beams intersect at point A. The incident light cone has an angle θᵢₙ (the angle between the central axis and the edge ray of the incident light cone); and the reflected light cone has angle θᵣₑ (the angle between the central axis and the edge ray of the reflected light cone). Incident light angle φ is the angle between the central axis of the light cone and the reflected surfaces of the mirror plates. L is the characteristic dimension of the mirror plate array, and also can be the distance between the remote mirror plates at the opposite ends of the mirror plate array. With the geometric configuration shown in FIG. 2b, distance Dₘᵢₙ can be expressed as:

$${D}_{min} = \frac{L}{{tan}^{- 1} ( {θ}_{in} + ϕ ) - tan ( {θ}_{re} )} \qquad ( equation 1 )$$

As an example, the distance Dₘᵢₙ is preferably 186 mm or less, 40 mm or less, 33 mm or less, 27 mm or less, 24 mm or less, 20.7 mm or less, 18 mm or less, and 17 mm or less. Accordingly, the projection lens may have a back-focal length of 186 mm or less, 40 mm or less, 33 mm or less, 27 mm or less, 24 mm or less, 20.7 mm or less, 18 mm or less, and 17 mm or less. The f-number of the projection lens can be from f/1.8 to f/4, more preferably around f/2.4 with f being the back-focal length.

The illumination light to be modulated by the spatial light modulator is provided by the illumination system, such as that shown in FIG. 1. An exemplary illumination system is demonstratively illustrated in FIG. 3. Referring to FIG. 3, illumination system 104 may comprise light source 122, light pipe 124, and color filter 126 such as a color wheel. Alternative to the illumination system 116 as shown in the figure wherein the color wheel is positioned after the light pipe along the propagation path of the illumination light from the light source, the color wheel can also be positioned between the light source and light pipe at the propagation path of the illumination light. The illumination light can be polarized or non-polarized. When polarized illumination light is used, the display target may comprise a polarization filter associated with the polarized illumination light, as set forth in U.S. provisional patent application Ser. No. 60/577,422 filed Jun. 4, 2004, the subject matter being incorporated herein by reference.

The light source can be any suitable light source, such as an arc lamp, preferably an arc lamp with a short arc for obtaining intensive illumination light. The light source can also be an arc lamp with a spiral reflector, as set forth in U.S. patent application Ser. No. 11/055,654 filed Feb. 9, 2005, the subject matter being incorporated herein by reference.

The lightpipe (124) can be a standard lightpipe that are widely used in digital display systems for delivering homogenized light from the light source to spatial light modulators. Alternatively, the lightpipe can be the one with movable reflective surfaces, as set forth in U.S. patent provisional application Ser. No. 60/620,395 filed Oct. 19, 2004, the subject matter being incorporated herein by reference.

The color wheel (126) comprises a set of color and/or white segments, such as red, green, blue, or yellow, cyan, and magenta. The color wheel may further comprise a clear or non-clear segment, such as a high throughput or white segment for achieving particular purposes, as set forth in U.S. patent application Ser. No. 10/899,637, and Ser. No. 10/899,635 both filed Jul. 26, 2004, the subject matter of each being incorporated herein by reference, which will not be discussed in detail herein.

Alternative to the arc lamp, LEDs can also be employed as the light source for providing illumination light beams due to many advantages, such as compact size, longer lifetime than arc lamps, lower heating than arc lamps, and narrower bandwidth than arc lamps. As an example, gallium nitride light emitting diodes can be used for the green and blue arrays, and gallium arsenide (aluminum gallium arsenide) could be used for the red light emitting diode array. LEDs such as available or disclosed by Nichia™ or Lumileds™ could be used, or any other suitable light emitting diodes. Some of the current LEDs have a lifetime of 100,000 hours or more, which is almost 10 times higher than the lifetime of the current UHP arc lamp with the longest lifetime. LEDs are cold light source, which yields much less heat than arc lamps. Even using multiple LEDs in a display system, the total heat generated by the LEDs can be dissipated much easier than using the arc lamps, because the heat generated by the LEDs is omni-directional as compared to the heat generated by the arc lamps wherein the heat has preferred orientations. Currently, LEDs of different colors have been developed. When multiple LEDs of different colors, such as red, green, and blue, are concurrently employed in the display system, beam splitting elements, such as color wheel, that are required for the arc lamp, can be omitted. Without light splitting elements, system design and manufacturing can be significantly simplified. Moreover, the display system can be made more compact and portable.

As compared to current arc lamps, LEDs are also superior in spectrum to arc lamps. The spectrum of a LED has a typical width of 10 nm to 35 nm. However, the typical spectrum width of the colors (e.g. red, green, and blue) derived from the color wheel used in combination with an arc lamp is approximately 70 nm, which is much larger than that of the LED. In other words, LEDs have much purer colors than arc lamps, resulting in more abundant colors than arc lamps.

Like arc lamps, LEDs may have the color balance problem, wherein different colors may have different intensities. This problem for LEDs, however, can be solved simply by time-mixing or spatial-mixing mode. In spatial-mixing mode, different number of LEDs for different colors can be provided for balancing the intensity discrepancies in different colors. In time-mixing mode, the color can be balanced by tuning the ON-time ratio of different LEDs for different colors.

To be commensurate with the display system, the LEDs used in the projection system preferably have a light flux of 3 lumens or higher, such as 4.4 lumens or higher, and 11.5 lumens or higher.

Using multiple LEDs of different colors has other practical benefits as compared to using the arc lamp and color wheel. In the display system using the arc lamp and color wheel, color transition unavoidably occurs as the color wheel spins and color fields in the color wheel sequentially sweeps across the micromirror array of the spatial light modulator. The color transition cast extra design for the system, which complicate the system. Moreover, color transition reduces optical efficiency of the system, for example, a portion of the incident light has to be sacrificed. As a comparison, LEDs may not have the color transition problem. Regardless whether the LEDs sequentially or concurrently illuminating the micromirror devices of the spatial light modulator, all micromirror devices of the spatial light modulator can be illuminated by a light beam of specific color at a time.

Referring to FIG. 3, an exemplary illumination system using LEDs as light source is demonstratively illustrated therein. In this example, the illumination system comprises a LED array (e.g. LEDs 130, 132, and 134) for providing illumination light beam for the system. For demonstration purposes only, three LEDs are illustrated in the figure. In practice, the LED group may have any suitable number of LEDs, including a single LED. The LEDs can be of the same color (e.g. white color) or different colors (e.g. red, green, and blue). The light beams from the LED array are projected onto front fly-eye lens 138 through collimation lens 136. Fly-eye lens 138 comprises multiple unit lenses such as unit lens 140. The unit lenses on fly-eye lens 138 can be cubical lens or any other suitable lenses, and the total number of the unit lenses in the fly-eye lens 138 can be any desired numbers. At fly-eye lens 138, the light beam from each of the LEDs 130, 132, and 134 is split into a number of sub-light beams with the total number being equal to the total number of unit lenses of fly-eye lens 138. After collimate lens 136 and fly-eye lens 138, each LED of the LED array is imaged onto each unit lens (e.g. unit lens 144) of rear fly-eye lens 142. Rear fly-eye lens 142 comprises a plurality of unit lenses each of which corresponds to one of the unit lenses of the front fly-eye lens 138, such that each of the LEDs forms an image at each unit lens of the rear fly-eye lens 142. Projection lens 146 projects the light beams from each unit lens of fly-eye lens 142 onto the spatial light modulator. With the above optical configuration, the light beams from the LED array can be uniformly projected onto the micromirror devices of the spatial light modulator.

In the display system, a single LED can be used, in which instance, the LED preferably provides white color. Alternatively, an array of LEDs capable of emitting the same (e.g. white) or different colors (e.g. red, green, and blue) can be employed. Especially when multiple LEDs are employed for producing different colors, each color can be produced by one or more LEDs. In practical operation, it may be desired that different colors have approximately the same or specific characteristic spectrum widths. It may also be desired that different colors have the same illumination intensity. These requirements can be satisfied by juxtaposing certain number of LEDs with slightly different spectrums. For example, assuming that the desired spectrum bandwidth of a specific color (e.g. red) is B, (e.g. a value from 10 nm to 80 nm, or from 60 nm to 70 nm), and the characteristic spectrum bandwidth of each LED of an array of LEDs is Bi (e.g. a value from 10 nm to 35 nm). By properly selecting the number of LEDs with suitable spectrum differences, the desired spectrum can be obtained. As a way of example, assuming that the red color with the wavelength of 660 nm and spectrum bandwidth of 60 nm is desired, LEDs of the array can be selected and juxtaposed as shown in the figure. The LEDs may have characteristic spectrum of 660 nm, 665 nm, 670 nm, and 675 nm, and the characteristic spectrum width of each LED is approximately 10 nm. As a result, the effective spectrum width of the juxtaposed LEDs can approximately be the desired red color with the desired spectrum width.

Different LEDs emitting different colors may exhibit different intensities, in which instance, the color balance is desired so as to generate different colors of the same intensity. An approach is to adjust the ratio of the total number of LEDs for the different colors to be balanced according to the ratio of the intensities of the different colors, such that the effective output intensities of different colors are approximately the same.

In the display system wherein LEDs are provided for illuminating a single spatial light modulator with different colors, the different colors can be sequentially directed to the spatial light modulator. For this purpose, the LEDs for different colors can be sequentially turned on, and the LEDs for the same color are turned on concurrently. In another system, multiple spatial light modulators can be used as set froth in U.S. patent application “Multiple Spatial Light Modulators in a Package” to Huibers, attorney docket number P266-pro, filed Aug. 30, 2005, the subject matter being incorporated herein by reference in entirety. A group of LEDs can be employed in such a display system for producing different colors that sequentially or concurrently illuminate the multiple spatial light modulators.

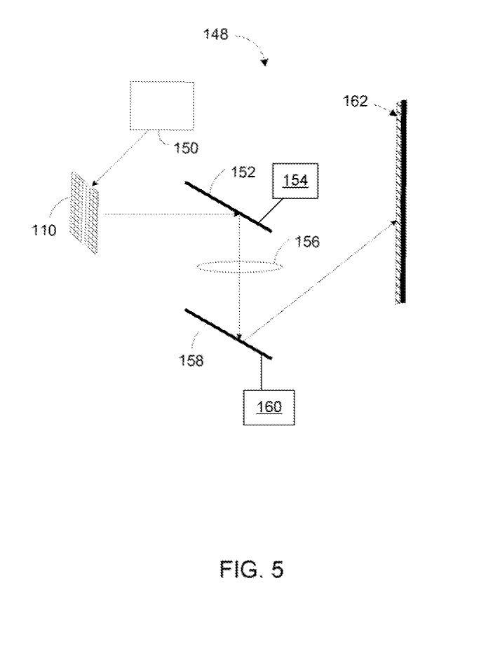

Another projection system is demonstratively illustrated in FIG. 5. Referring to FIG. 5, projection system 148 comprises illumination system 150 providing light beams to illuminate spatial light modulator 1 10. The spatial light modulator comprises an array of reflective and deflectable mirror plates. The spatial light modulator modulates the incident light according to a stream of image data (such as bitplane data) that are derived from the desired images and video signals. The modulated light beams are then reflected by mirror 152 that reflects the modulated light beams to another mirror 158 through projection lens 156. The light beams reflected from mirror 158 are then projected to display target 162 so as to generate a pixel pattern.

The spatial light modulator can be the same as that in FIG. 1, and so are the projection lens and illumination system, which will not be discussed in detail herein. Mirror 152 or mirror 158 or both can be movable. For example, mirror 152 can be rotated in the plane of the paper along a rotation axis that points out from the paper. Such rotation can be driven accomplished by micro-actuator 154 (e.g. a piezo-actuator) connected to mirror 152. Similarly, mirror plate 158, if necessary, can be connected to micro-actuator 160 for rotating mirror 158.

By rotating mirror 152 or mirror 158 or both, the pixel patterns generated by the pixels of the spatial light modulator according to the image data can be moved spatially across the image area (the area where the desired images and videos are projected) in the display target so as to obtain the projected images and videos with a higher resolution than the real physical resolution (the number of physical pixels in the spatial light modulator) of the spatial light modulator, as set forth in provisional U.S. patent application Ser. No. 60/678,617 filed May 5, 2005, the subject matter being incorporated herein by reference in entirety.

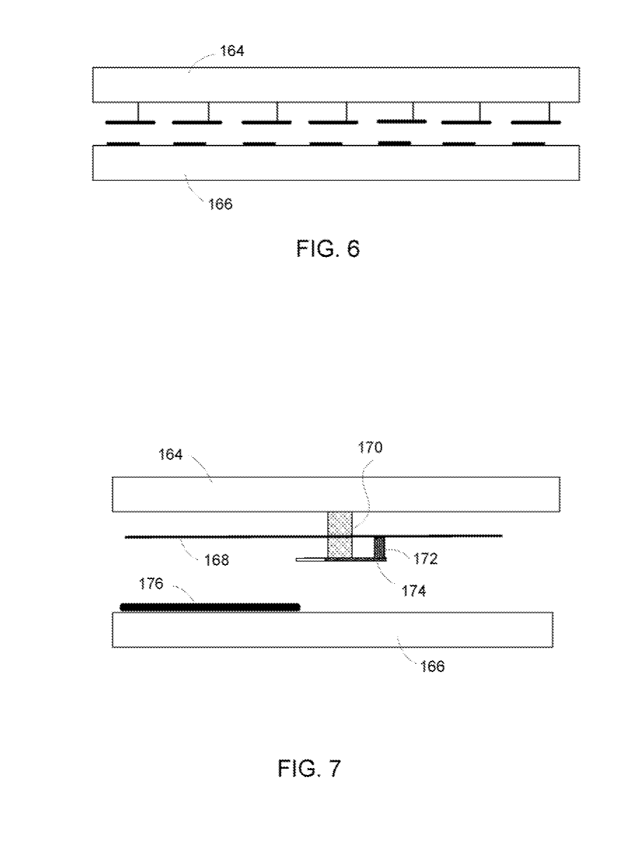

The spatial light modulator as discussed above may have any suitable configurations, one of which is illustrated in FIG. 6. Referring to FIG. 6, the reflective and deflectable mirror plates are formed on light transmissive substrate 164, such as glass, quartz, and sapphire. The addressing electrodes are formed on semiconductor substrate 166. The two substrates can be bonded together with a spacer so as to maintain a uniform and constant vertical distance therebetween.

The spatial light modulator may have other features, such as a light transmissive electrode formed on the light transmissive substrate, as set forth in U.S. patent application Ser. No. 11/102,531 filed Apr. 8, 2005, the subject matter being incorporated herein by reference in its entirety.

Alternative to forming the mirror plates on a separate substrate than the semiconductor substrate on which the addressing electrodes are formed, the mirror plates and addressing electrodes can be formed on the same substrate, which preferably the semiconductor substrate, which is not shown in the figure.

In another embodiment, the mirror plates can be derived from a single crystal, such as single crystal silicon, as set forth in U.S. patent application Ser. No. 11/056,732, Ser. No. 11/056,727, and Ser. No. 11/056,752 all filed Feb. 11, 2005, the subject matter of each being incorporated herein by reference in entirety.

The micromirrors as shown in FIG. 6 have a variety of different configurations, one of which is demonstratively illustrated in a cross-sectional view in FIG. 7. Referring to FIG. 7, the micromirror device comprises reflective deflectable mirror plate 168 that is attached to deformable hinge 174 via hinge contact 172. The deformable hinge, such as a torsion hinge is held by a hinge support that is affixed to post 170 on light transmissive substrate 164. Addressing electrode 176 is disposed on semiconductor substrate 166, and is placed proximate to the mirror plate for electrostatically deflecting the mirror plate. Other alternative features can also be provided. For example, a stopper can be provided for limiting the rotation of the mirror plate when the mirror plate is at the desired angles, such as the ON state angle. The ON state angle is preferably 10° degrees or more, 12° degrees or more, or 14° degrees or more relative to substrate 164. For enhancing the transmission of the incident light through the light transmissive substrate 164, an anti-reflection film can be coated on the lower surface of substrate 164. Alternative the anti-reflection film, a light transmissive electrode can be formed on the lower surface of substrate 164 for electrostatically deflecting the mirror plate towards substrate 164. An example of such electrode can be a thin film of indium-tin-oxide. The light transmissive electrode can also be a multi-layered structure. For example, it may comprise an electrically conductive layer and electrically non-conductive layer with the electrically conductive layer being sandwiched between substrate 252 and the electrically non-conductive layer. This configuration prevents potential electrical short between the mirror plate and the electrode. The electrically non-conductive layer can be SiOₓ, TiOₓ, SiNₓ, and NbOₓ, as set forth in U.S. patent application Ser. No. 11/102,531 filed Apr. 8, 2005, the subject matter being incorporated herein by reference. Alternatively, multiple addressing electrodes can be provided for the micromirror device, as set forth in U.S. patent application Ser. No. 10/437,776 filed May 13, 2003, and Ser. No. 10/947,005 filed Sep. 21, 2004, the subject matter of each being incorporated herein by reference in entirety. Other optical films, such as a light transmissive and electrically insulating layer can be utilized in combination with the light transmissive electrode on the lower surface of substrate 164 for preventing possible electrical short between the mirror plate and light transmissive electrode.

In the example shown in FIG. 7, the mirror plate is associated with one single addressing electrode (e.g. electrode 176) on substrate 166. Alternatively, another addressing electrode can be formed on substrate 166, but on the opposite side of the deformable hinge.

The micromirror device as show in FIG. 7 is only one example of many applicable examples. For example, in the example as shown in FIG. 7 the mirror plate is attached to the deformable hinge such that the mirror plate rotates asymmetrically. That is the maximum rotation angle (e.g. the ON state angle) achievable by the mirror plate rotating in one direction (the direction towards the ON state) is larger than that (e.g. the OFF stat angle) in the opposite rotation direction (e.g. the direction towards the OFF state). This is accomplished by attaching the mirror plate to the deformable hinge at a location that is not at the center of the mirror plate such that the rotation axis of the mirror plate is offset from a diagonal of the mirror plate. However, the rotation axis may or may not be parallel to the diagonal. Of course, the mirror plate can be attached to the deformable hinge such that the mirror plate rotates symmetrically. That is the maximum angle achievable by rotating the mirror plate is substantially the same as that in the opposite rotation direction.

The mirror plate of the micromirror shown in FIG. 7 can be attached to the deformable hinge such that the mirror plate and deformable hinge are in the same plane. In an alternative example, the deformable hinge can be located in a separate plane as the mirror plate when viewed from the top of the mirror plate at a non-deflected state, which will not be discussed in detail herein.

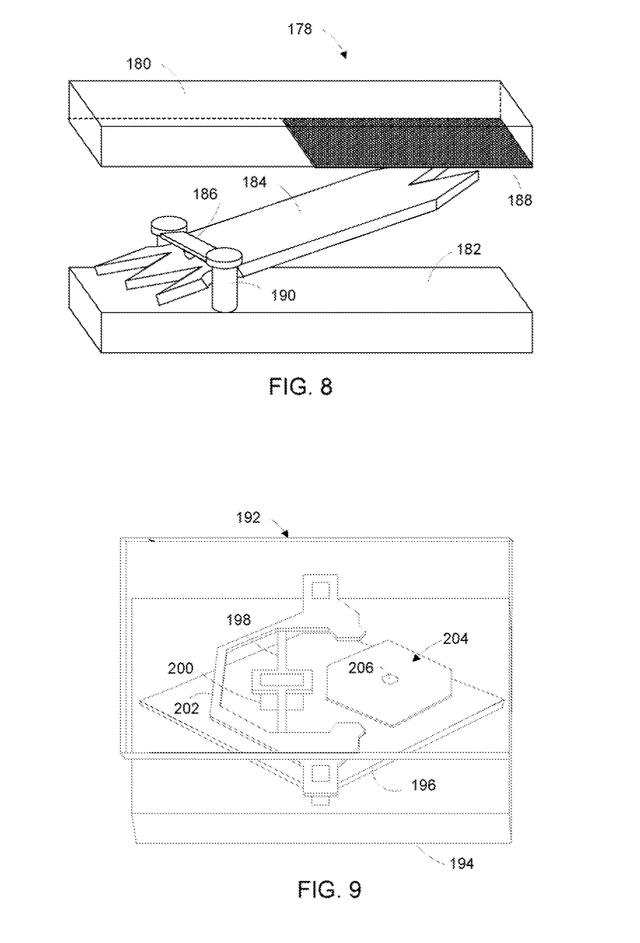

In the following, selected exemplary micromirror devices having the cross-sectional view of FIG. 7 will be discussed with reference to FIG. 8 and FIG. 9. It will be immediately understood by those skilled in the art that the following discussion is for demonstration purposes only and is not intended to be limiting.

Referring to FIG. 8, a perspective view of an exemplary micromirror device is illustrated therein. Micromirror device 178 comprises substrate 182 that is a light transmissive substrate such as glass, quartz, and sapphire and semiconductor substrate 180, such as silicon substrate. Deflectable and reflective mirror plate 184 is spaced apart and attached to deformable hinge 186 via a hinge contact. The deformable hinge is affixed to and held by posts 190. The semiconductor substrate has addressing electrode 188 for deflecting the mirror plate. A light blocking pad can be alternatively formed between the surface of post 190 and substrate 182 for reducing unexpected light scattering from the exposed surface of the posts.

The deflectable and reflective mirror plate can be a multilayered structure. For example, the mirror plate may comprise an electrical conducting layer, a reflective layer that is capable of reflecting 85% or more, or 90% or more, or 85% or more, or 99% or more of the incident light (e.g. incident visible light), a mechanical enhancing layer that enhances the mechanical properties of the mirror plate. An exemplary mirror plate can be a multilayered structure comprising a SiO₂ layer, an aluminum layer, a titanium layer, and a titanium nitride layer. When aluminum is used for the mirror plate; and amorphous silicon is used as the sacrificial material, diffusion between the aluminum layer and the sacrificial material may occur. This can be avoided by depositing a barrier layer therebetween.

Another exemplary micromirror device having a cross-sectional view of FIG. 7 is illustrated in its perspective view in FIG. 9. Referring to FIG. 9, deflectable reflective mirror plate 196 with a substantially square shape is formed on light transmissive substrate 194, and is attached to deformable hinge 198 via hinge contact 200. The deformable hinge is held by hinge support 202, and the hinge support is affixed and held by posts on the light transmissive substrate. For electrostatically deflecting the mirror plate, an addressing electrode (not shown in the figure for simplicity purposes) is fabricated in the semiconductor substrate 192. For improving the electrical coupling of the deflectable mirror plate to the electrostatic field, extending metallic plate 204 can be formed on the mirror plate and contacted to the mirror plate via post 206. A light blocking pad can be alternatively disposed between the surface of the post and substrate 194 so as to reduce unexpected light scattering from the post. The light blocking pad can also be deployed in a way so as to block light scattered from other portions of the micromirror, such as the tips (or the corners) of the mirror plate of the micromirror, and the exterior surfaces (e.g. the walls) of the posts.

The mirror plate is preferably attached to the deformable hinge asymmetrically such that the mirror plate can be rotated asymmetrically for achieving high contrast ratio. Similar to that shown in FIG. 8, the deformable hinge is preferably formed beneath the deflectable mirror plate in the direction of the incident light so as to avoid unexpected light scattering by the deformable hinge. For reducing unexpected light scattering of the mirror plate edge, the illumination light is preferably incident onto the mirror plate along a corner of the mirror plate.

Referring to FIG. 10, an exemplary spatial light modulator having an array of micromirrors of FIG. 9 is illustrated therein. For simplicity purposes, only 4×4 micromirrors are presented. In general, the micromirror array of a spatial light modulator consists of thousands or millions of micromirrors, the total number of which determines the resolution of the displayed images. For example, the micromirror array of the spatial light modulator may have 800×600 (SVGA) or higher, 1024×768 (XGA) or higher, 1280×1024 (SXGA) or higher, 1280×720 or higher, 1400×1050 or higher, 1600×1200 (UXGA) or higher, and 1920×1080 or higher, micromirror devices. In other applications, the micromirror array may have less number of micromirrors.

In this example, the array of deflectable reflective mirror plates 214 is disposed between light transmissive substrate 210 and semiconductor substrate 212 having formed thereon an array of addressing electrodes 216 each of which is associated with a mirror plate for electrostatically deflecting the mirror plate. The posts of the micromirrors can be covered by light blocking pads for reducing expected light scattering from the surfaces of the posts.

In operation, the illumination light passes through the light transmissive substrate and illuminates the reflective surfaces of the mirror plates, from which the illumination light is modulated. The illumination light incident onto the areas corresponding to the surfaces of the posts are blocked (e.g. reflected or absorbed depending upon the materials of the light blocking pads) by the light blocking pads. The reflected illumination light from the mirror plates at the ON state is collected by the projection lens so as to generate a “bright” pixel in the display target. The reflected illumination from the mirror plates at the OFF state travels away from the projection lens, resulting in the corresponding pixels imagined at the display target to be “dark.”

The micromirrors in the micromirror array of the spatial light modulator can be arranged in alternative ways, another one of which is illustrated in FIG. 11. Referring to FIG. 11, each micromirror is rotated around its geometric center an angle less than 45° degrees, such as 20° degrees or less, and around 12.2 degrees. The posts (e.g. 220 and 222) of each micromirror (e.g. mirror 218) are then aligned to the opposite edges of the mirror plate. No edges of the mirror plate are parallel to an edge (e.g. edges 224 or 226) of the micromirror array. The rotation axis (e.g. axis 228) of each mirror plate is parallel to but offset from a diagonal of the mirror plate when viewed from the top of the mirror plate at a non-deflected state.

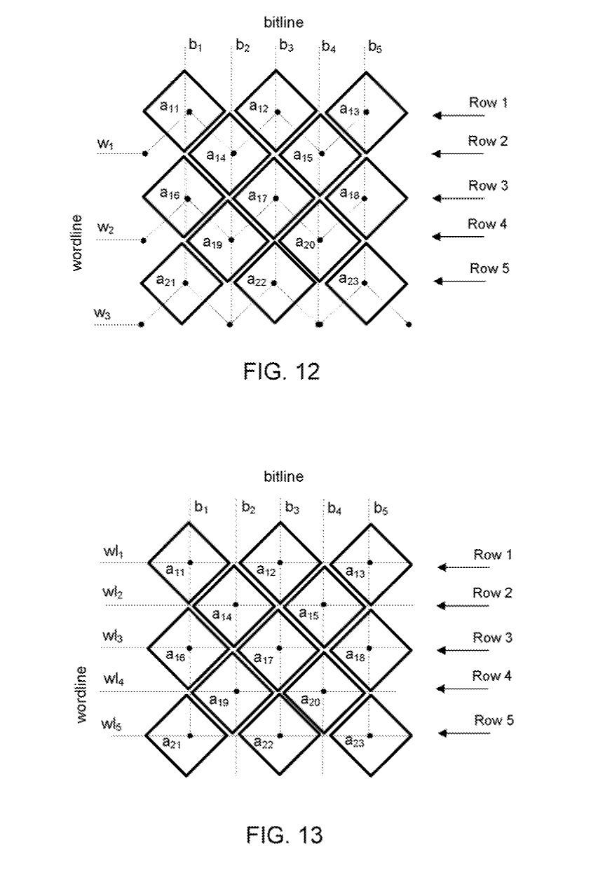

FIG. 12 illustrates the top view of another micromirror array having an array of micromirrors of FIG. 7. In this example, each micromirror is rotated 45° degrees around its geometric center. For addressing the micromirrors, the bitlines and wordlines are deployed in a way such that each column of the array is connected to a bitline but each wordline alternatively connects micromirrors of adjacent rows. For example, bitlines b₁, b₂, b₃, b₄, and b₅ respectively connect micromirrors groups of (a₁₁, a₁₆, and a₂₁), (a₁₄ and a₁₉), (a₁₂, a₁₇, and a₂₂), (a₁₅ and a₂₀), and (a₁₃, a₁₈, and a₂₃), Wordlines w₁, w₂, and w₃ respectively connect micromirror groups (a₁₁, a₁₄, a₁₂, a₁₅, and a₁₃), (a₁₆, a₁₉, a₁₇, a₂₀, and a₁₈), and (a₂₁, a₂₂, and a₂₃). With this configuration, the total number of wordlines is less the total number of bitlines.

For the same micromirror array, the bitlines and wordlines can be deployed in other ways, such as that shown in FIG. 13. Referring to FIG. 13, each row of micromirrors is provided with one wordline and one bitline. Specifically, bitlines b₁, b₂, b_{3,}, b₄ and b₅ respectively connect column 1 (comprising micromirrors a₁₁, a₁₆, and a₂₁), column 2 (comprising micromirrors a₁₄ and a₁₉), column 3 (comprising micromirrors a₁₂, a₁₇, and a₂₂), column 4 (comprising micromirrors a₁₅ and a₂₀), and column 5 (comprising micromirrors a₁₃, a₁₈, and a₂₃). Wordlines WL₁, WL₂, WL₃, WL₄, and WL₅ respectively connect row 1 (comprising micromirrors a₁₁, a₁₂, and a₁₃), row 2 (comprising micromirrors a₁₄ and a₁₅), row 3 (comprising micromirrors a₁₆, a₁₇, and a₁₈), row 4 (comprising micromirrors a₁₉ and a₂₀) and row 5 (comprising micromirrors a₂₁, a₂₂, and a₂₃).

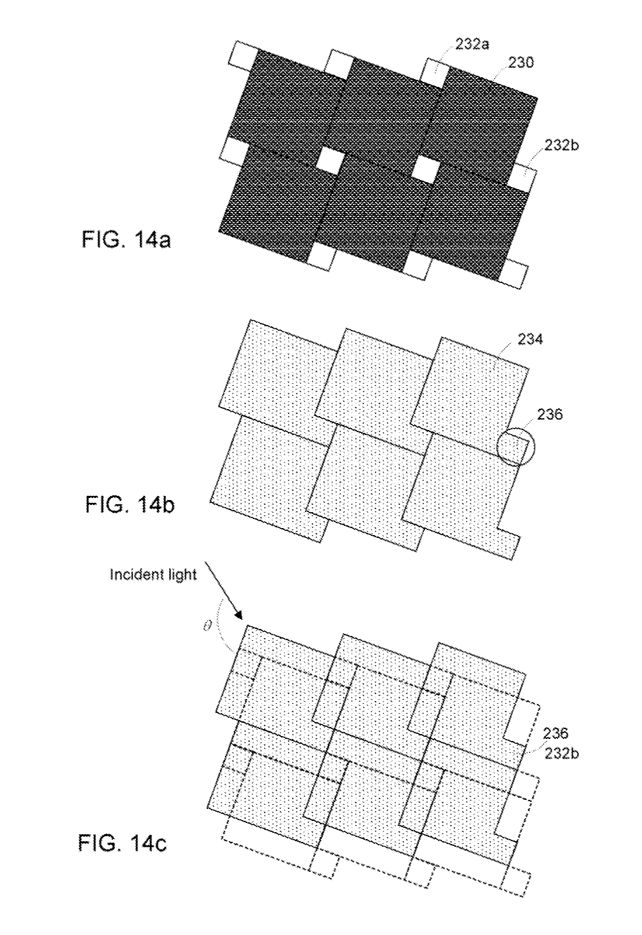

In another example, the mirror plates of the micromirrors in the array can form a plurality of pockets, in which posts can be formed, wherein the pockets are covered by the extended areas of the addressing electrodes when viewed from the top of the micromirror array device, as shown in FIGS. 14a to 14c.

Referring to FIG. 14a, a portion of an array of mirror plates of the micromirrors is illustrated therein. The mirror plates in the array form a plurality of pockets in between. For example, pockets 232a and 232b are formed in which posts for supporting and holding mirror plate 230 can be formed. For individually addressing and deflecting the mirror plates in FIG. 14a, an array of addressing electrodes is provided, a portion of which is illustrated in FIG. 14b.

Referring to FIG. 14b, each addressing electrode has an extended portion, such as extended portion 236 of addressing electrode 234. Without the extended portion, the addressing electrode can be generally square, but having an area equal to or smaller than the mirror plate.

FIG. 14c illustrates a top view of a micromirror array device after the addressing electrodes in FIG. 14b and the mirror plates in FIG. 14a being assembled together. It can be seen in the figure that each addressing electrode is displaced a particular distance along a diagonal of the mirror plate associated with the addressing electrode. As a result, the pockets presented between the mirror plates are covered by the addressing electrode, specifically by the extended portions of the addressing electrodes. In this way, light scattering otherwise occurred in the substrate having the addressing electrodes can be removed. The quality, such as the contrast ratio of the displayed images can be improved.

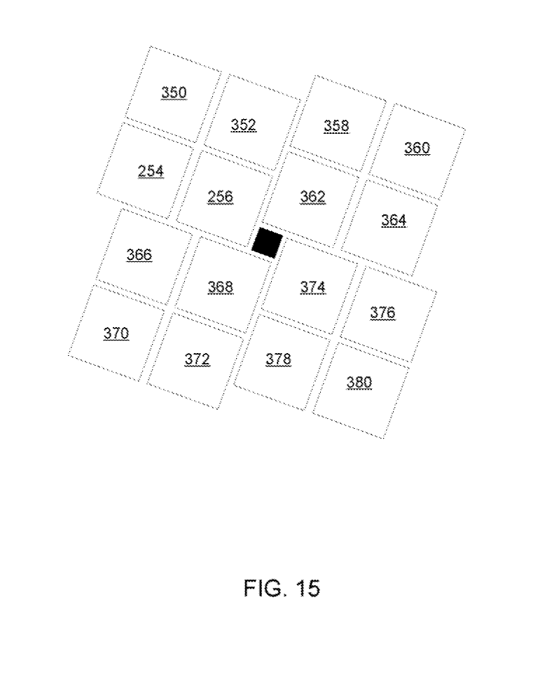

In an example, not all the micromirror devices of a spatial light modulator have posts (e.g. at that set forth in U.S. patent application Ser. No. 10/969,251 and Ser. No. 10/969,503 both filed Oct. 19, 2004, the subject matter of each being incorporated herein by reference in entirety. An example of such micromirror array device is illustrated in a top view in FIG. 15. For simplicity purposes, only sixteen micromirror devices of the micromirror array device are illustrated. In this specific example, every four adjacent micromirrors are formed into a micromirror group, such as the group comprising micromirrors 350, 352, 254, and 356, the group comprising 358, 360, 362, and 364, the group comprising micromirrors 366, 368, 370, and 372, and the group comprising micromirrors 374, 376, 378 and 380. Adjacent groups (e.g. the above four micromirror groups) share a post that is represented by the black square for supporting the mirror plates of the micromirrors in the four micromirror groups. The exposed surface of the post can be covered by a light blocking film. In general, the posts of a micromirror array device, wherein not all micromirrors are provided with a post, can all be coated with light blocking pads. Alternatively, only a number of (but not all) the posts are coated with light blocking pads.

It will be appreciated by those skilled in the art that a new and useful micromirror-based rear-projection system employing a projection lens with a short focal length has been described herein. In view of the many possible embodiments, however, it should be recognized that the embodiments described herein with respect to the drawing figures are meant to be illustrative only and should not be taken as limiting the scope of what is claimed. Those of skill in the art will recognize that the illustrated embodiments can be modified in arrangement and detail. Therefore, the devices and methods as described herein contemplate all such embodiments as may come within the scope of the following claims and equivalents thereof.

1. A projection system, comprising:
an illumination system providing light;
an array of reflective and deflectable mirror plates for modulating the incident light in accordance with a stream of image data;
a projection lens for projecting the modulated light onto a translucent screen;
wherein each mirror plate is capable of being rotated to an ON state angle from a natural resting state with the ON state angle being 14° degrees or higher; and
wherein the projection lens has a back-focal length of 20.7 mm or less.

2. (canceled)

3. The system of claim 1, wherein the back-focal length is 17 mm or less.

4. The system of claim 1, wherein the distance between the projection lens and the mirror plate at the natural resting state is 20.7 mm or less

5. (canceled)

6. The system of claim 1, wherein the distance between the projection lens and the mirror plate at the natural resting state is 17 mm or less

7. The system of claim 1, further comprising: a relay lens for directing light from the illumination system to the array of mirror plates.

8. The system of claim 1, wherein the f-number of the projection lens is from f/1.8 to f/4.

9. The system of claim 1, wherein the f-number of the projection lens is around f/2.4.

10-12. (canceled)

13. The system of claim 1, wherein the difference between the ON and OFF state angles is 14° degrees or more.

14-30. (canceled)

31. The system of claim 1, wherein the illumination system comprises an arc lamp, a lightpipe, and a color wheel, and wherein the color wheel is positioned after the lightpipe and the light source at a propagation path of the light from the light source.

32-37. (canceled)

38. A projection system, comprising:
an illumination system providing light;
an array of reflective and deflectable mirror plates for modulating the incident light in accordance with a stream of image data;
a projection lens for projecting the modulated light onto a translucent screen;
wherein each mirror plate is capable of being rotated to an ON state angle from a natural resting state with the ON state angle being 14° degrees or higher; and
a relay lens positioned at a propagation path of the illumination light onto the mirror plate array.

39. The system of claim 38, wherein the projection lens has a back-focal length of 20.7 mm or less.

40. (canceled)

41. The system of claim 39, wherein the back-focal length is 17 mm or less.

42. The system of claim 39, wherein the distance between the projection lens and the mirror plate at the natural resting state is 20.7 mm or less

43-45. (canceled)

46. The system of claim 39, wherein the f-number of the projection lens is from f/1.8 to f/4.

47. The system of claim 39, wherein the f-number of the projection lens is around f/2.4.

48. A projection system, comprising:
an illumination system providing light;
an array of reflective and deflectable mirror plates for modulating the incident light in accordance with a stream of image data derived from a desired image;
a projection lens for projecting the modulated light onto a translucent screen such that the desired image projected thereon can be viewed from the opposite side of the screen by a viewer; and
a relay lens displaced at a propagation path of the illumination light onto the micromirror array.

49. The system of claim 48, wherein the projection lens has a back-focal length of 20.7 mm or less.

50. (canceled)

51. The system of claim 49, wherein the back-focal length is 17 mm or less.

52. The system of claim 49, wherein the distance between the projection lens and the mirror plate at the natural resting state is 20.7 mm or less

53. (canceled)

54. The system of claim 49, wherein the distance between the projection lens and the mirror plate at the natural resting state is 17 mm or less

55. (canceled)

56. The system of claim 49, wherein the f-number of the projection lens is from f/1.8 to f/4.

57. The system of claim 49, wherein each mirror plate is capable of being rotated to an ON state angle from a natural resting state with the ON state angle being 14° degrees or higher; and

58. (canceled)

59. The system of claim 56, wherein the f-number is around f/2.4.
